(19) United States
(12) Patent Application Publication
(10) Pub. No.: US 2007/0240810 A1
(43) Pub. Date: Oct. 18, 2007

(54) Linear process for manufacture of fiber batts

(75) Inventor: Surendra Khambete, West Bloomfield, MI (US)

Correspondence Address: CARLSON, GASKEY & OLDS, P.C., 400 WEST MAPLE ROAD, SUITE 350, BIRMINGHAM, MI, 48009, US

(73) Assignee: Indra Tech LLC

(21) Appl. No.: 11/404,263

(22) Filed: Apr. 12, 2006

(51) Int. Cl. B29C 70/52

(52) U.S. Cl. 156/166; 156/543

(57) ABSTRACT

A machine includes a conveyer that is movable along a generally linear path. Two fiber chutes deliver fiber to the conveyer. First and second heaters and compression devices are used to provide different densities to the different fiber layers. A first heater and first compression device is used to compress a first fiber layer prior to depositing the first fiber layer onto a second fiber layer. The compressed first fiber layer and uncompressed second fiber layer are conveyed to the second heater and second compression device where both layers are heated and compressed. Aesthetic layer may also be applied to at least one of the layers. A third layer may be provided on the first layer opposite the second layer. The compression devices are adjustable by an actuator for processing fiber batts having different thicknesses on the same machine. Adjustable trimmers are used to trim the sides of the continuous fiber batts and cut the batts to a desired width, height and length.

### BACKGROUND OF THE INVENTION

This invention relates to a method and machine for manufacturing fiber batts, and in particular the invention relates to a generally linear manner in which to make multilayer fiber batts.

Processes exist for forming fiber materials into batts. In a typical process, the fiber is loaded at a station and then moved, at time along a tortuous path, to one or more subsequent stations where the fiber is heated and compressed to a desired density and in a desired shape. The formed fiber batt is then trimmed at yet another station. Some processes enable formation of batts having multiple layers and varying densities, which requires additional stations.

The stations in the manufacturing processes described above are remote from one another such that a discrete amount of fiber is moved from station to station. The handling of the fiber in this manner increases the cycle time, which reduces the efficiency and cost competitiveness of fiber products as compared to similar foam products. Furthermore, the prior art processes are not very efficient in manufacturing generally flat batts in high volumes efficiently.

### SUMMARY OF THE INVENTION

The present invention provides a machine having a conveyer that is movable along a generally linear path. In one example, at least two fiber chutes deliver fiber to the conveyer. First and second heaters and compression devices are used to provide different densities to the different fiber layers, in the example shown. A first heater and first compression device is used to compress a first fiber layer prior to depositing the first fiber layer onto a second fiber layer. The compressed first fiber layer and an uncompressed second fiber layer are conveyed to the second heater and second compression device where both layers are heated and compressed. Aesthetic layer may also be applied to at least one of the layers. Additionally, a third layer can be provided on the first layer opposite the second fiber layer.

The compression devices are adjustable using an actuator for processing fiber batts having different thicknesses on the same machine. Adjustable trimmers can be used to trim the sides of the batts and cut the continuous fiber batts to a desired width, height and length.

These and other features of the present invention can be best understood from the following specification and drawings, the following of which is a brief description.

### BRIEF DESCRIPTION OF THE DRAWINGS

FIG. 1 is a schematic, top elevational view of a machine for forming fiber batts.

FIG. 2 is a schematic, side elevational view of a portion of the machine shown in FIG. 1.

FIG. 3A is a schematic, top elevational view of adjustable trimmers for cutting the fiber batt to a desired width and length.

FIG. 3B is a schematic, side elevational view of an adjustable trimmer for cutting the fiber batt to a desired height.

FIG. 4 is a cross-sectional view of one example fiber batt formed with the machine shown in FIG. 1.

### DETAILED DESCRIPTION OF THE PREFERRED EMBODIMENT

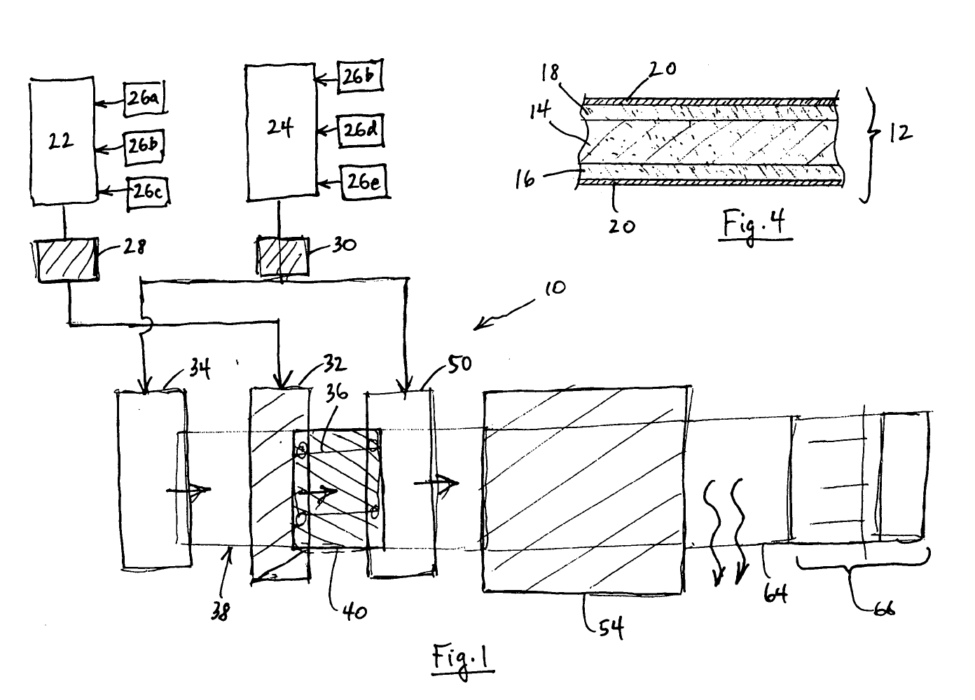

A machine 10 is shown in FIG. 1 for making a generally continuous fiber batt. An example fiber batt 12 manufactured using the machine 10 is shown in FIG. 4. The fiber batt 12 may provide a cushion or mattress as an end product. The fiber batt 12 includes a first fiber layer 14 with second and third fiber layers 16 and 18 on opposing sides of the first fiber layer 14. Aesthetic layer 20 can be arranged on the exterior of the fiber batt 12 on either side. The machine 10 is capable of providing the first layer 14 with a greater density than the second and third fiber layers 16 and 18. Additionally, different blends may be used for each of the fiber layers first, second and third fiber layers 14, 16 and 18.

The fiber batt 12 may be constructed from polyester fibers, and the layers 14, 16, 18 and 20 can be secured or bonded to one another. Although the fiber batt 12 is described as being constructed from a polyester material, other materials may be used. The fiber batt 12 and layers 14, 16, 18 and 20 (and other layers, if used) are polyester-based in one example, which provides a completely recyclable end product, unlike polyurethane. The polyester is selected to have desirable acoustic and flammability properties for the application in which the end product is used.

In one example, adhesive layers (not shown) are used to secure the aesthetic layers 20 to the second and third fiber layers 16 and 18. Some examples of suitable adhesives are polyester-, acrylic-, or polypropylene-based adhesives. It is typically desirable to use adhesives that can stretch along with the aesthetic layer while retaining its bond. In the example shown in FIG. 4, the first fiber layer 14 acts as a cushion, and the second and third fiber layers 16 and 18 provide “soft touch” layers, which have a lower density that the cushion layer. Other layers may be used, for example, an acoustic layer or a fire retardant layer. The aesthetic layers 20 may, for example, be a leather, vinyl or fabric material specified by the customer. Of course, any number and types of layers may be used.

Returning to FIG. 1, the machine 10 includes first and second blend lines 22 and 24. Each of the blend lines can provide different blends of fibers to the machine. In one example, the first blend line 22 receives fibers 26a, 26b and 26c, and the second blend line 24 receives fibers 26b, 26d and 26e. In the example shown, the first blend line 22 provides the middle layer of the fiber batt, and the second blend line 24 provides the outer fiber layers. Of course, it should be understood that fewer or more blend lines and fibers could be used.

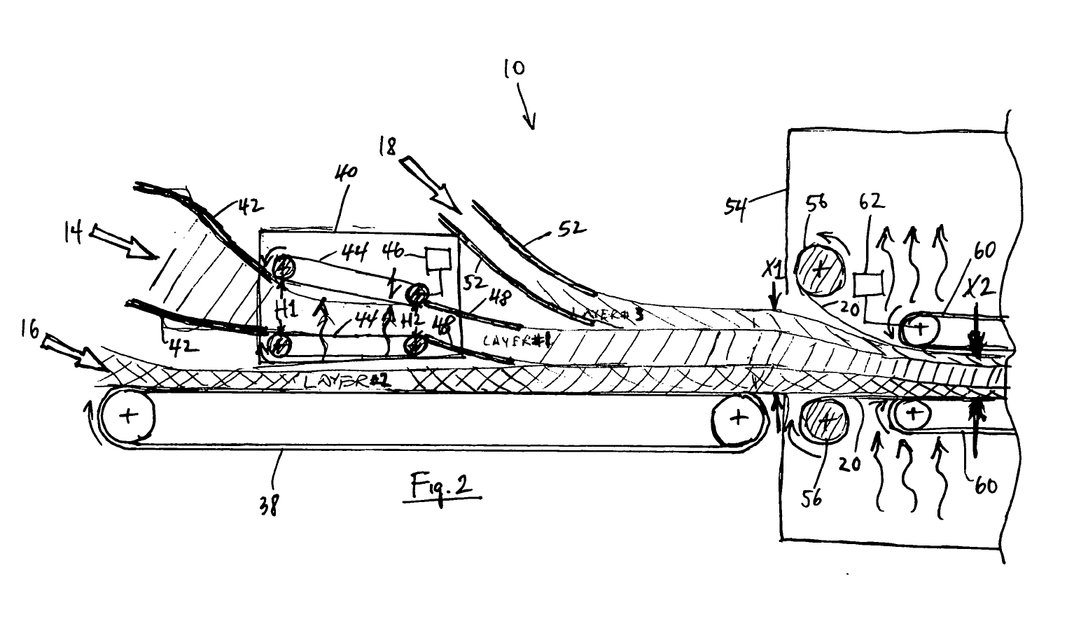

The first and second blend lines 22 and 24 respectively provide the blended fibers to openers 28 and 30. From the opener 28, the first blend line 22 feeds its fibers to a chute 32. “Chute” simply means a device that delivers the fiber and is not intended to exclude webbers, even feed or air-lay machines, or any other mechanism. The first fiber layer 14 is schematically shown exiting the chute 32 between spaced apart guides 42, shown in FIG. 2. The first fiber layer 14 is fed into a compression device 36 and heater 40. Simultaneously, the second fiber layer 16 is fed on a conveyer 38 from a chute 34 beneath the first fiber layer 14.

Conveyers 44 are spaced apart from one another and move the first fiber layer 14 through the heater 40. In the example shown, the top conveyer 44 is adjustable using an adjusting mechanism 46. The entrance to the conveyers 44 provides an initial height H1 and exit height H2. Thus, the first layer 14 is heated and compressed prior to being deposited on the second layer 16. The first fiber layer 14 exits the heater 40 and compression device 36 through exit guides 48. The first layer 14 need not be heated. Further, more than one layer can be processed through the heater 40 and compression device 36, if desired.

The third fiber layer 18 exits the chute 50 and enters spaced apart guides 52, as shown in FIG. 2. The first, second, and third fiber layers 14, 16 and 18 enter another heater 54 at a height X1. Laminators 56 arranged on either side of the layers 16 and 18 apply an aesthetic layer 20 prior to being compressed by spaced apart conveyers 60. As shown in the example in FIG. 2, the top conveyer 60 is adjustable using adjustment mechanisms 62 to set a desired compression height X2.

Heating the first layer 14 prior to heating and compressing all three layers ensures that the first fiber layer 14, which is in the middle, is adequately heated. Moreover, the machine 10 also enables the first fiber layer 14 to have a greater density than the outer fibers layers. In one example, the outer fiber layers may be two inches prior to compression and the middle fiber layer may be eight inches prior to initial compression. The middle fiber layer is compressed to a predetermined height, and then all three fiber layers are then again compressed. In one example, the outer fiber layers may have a final compression height of one inch and the middle fiber layer may have a final compression height of three inches. Thus, the middle fiber layer is denser than the outer fiber layers. Although not shown, the second and third fiber layer 16 and 18 may also be compressed prior to the final compression. Moreover, fewer or greater than the number of layers shown may be used.

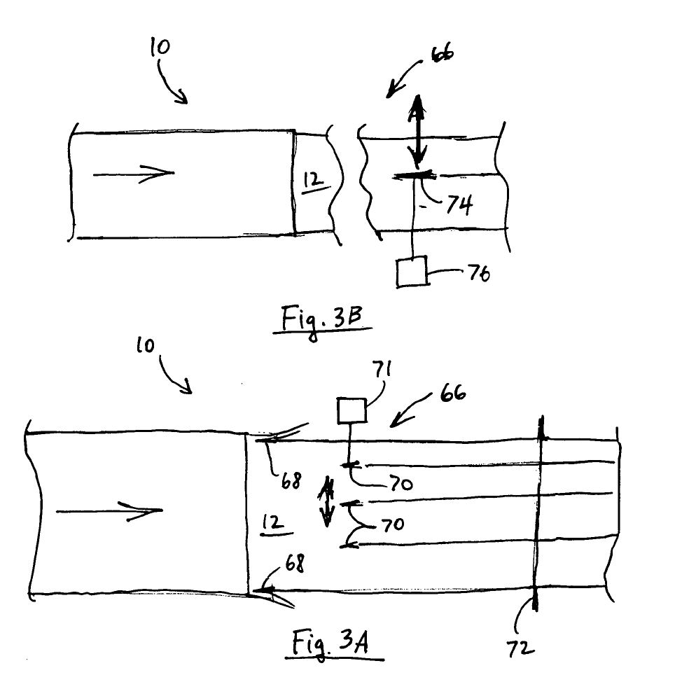

Returning to FIG. 1, a cooling device 64 cools the fiber batt 12 so that the desired shape sets prior to trimming. Cutters 66 are generally shown in FIG. 1, and are used to trim the generally continuous fiber batt to a desired shape. As shown in FIG. 3A, edge trimmers 68 are used to trim the fiber batt to an overall desired width. Vertical cutters 70, which may be adjustable using adjustment mechanism 71, cut the fiber batt 12 into smaller widths, if desired. A horizontal cutter 74 is used to cut the fiber batt into a desired height, and an adjustment mechanism 76 is used to actuate the horizontal cutter 74. Finally, a cross-cutter 72 is used to cut the generally continuous fiber batt into desired lengths.

Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1. A method of forming a fiber batt comprising the steps of:
a) loading a second fiber layer onto a first fiber layer while conveying the first and second fiber layers in a generally linear path; and
b) compressing at least one of the first and second fiber layers prior to performing step a).

2. The method according to claim 1, comprising the step of heating the at least one of the first and second fiber layers prior to performing step a).

3. The method according to claim 2, wherein step b) includes heating and compressing the second fiber layer.

4. The method according to claim 1, comprising step c) loading a third fiber layer onto the second fiber layer subsequent to performing step b).

5. The method according to claim 4, comprising step d) heating and compressing the first, second and third fiber layers.

6. The method according to claim 5, comprising step e) compressing the first, second and third fiber layers.

7. The method according to claim 6, comprising step f) applying an aesthetic layer to an exterior of at least one of the first and third layers.

8. The method according to claim 7, wherein step f) is performed prior to step e).

9. A method of forming a fiber batt comprising the steps of:
a) compressing a first fiber layer;
b) conveying the first fiber layer in a generally linear path; and
c) loading a second fiber layer onto the first fiber layer.

10. The method according to claim 9, comprising step d) compressing the first and second fiber layers subsequent to performing step c).

11. The method according to claim 9, comprising step b1) loading the first fiber layer onto a third fiber layer subsequent to performing step a).

12. The method according to claim 11, comprising the step of compressing the first, second and third fiber layers subsequent to performing step c).

13. The method according to claim 12, comprising step c1) heating the first, second and third fiber layers prior to performing step d).

14. The method according to claim 11, comprising step d) applying an aesthetic layer to an exterior of at least one of the second and third layers.

15. A machine for forming a fiber batt comprising:
a conveyer movable in along a generally linear path;
first and second fiber chutes for respectively providing first and second fiber layers to the conveyer;
a first heater arranged to receive at least one of the first and second fiber layers; and
first and second compression devices, the first compression device arranged for receiving one of the first and second fiber layers, and the second compression device for receiving the first and second fiber layers.

16. The machine according to claim 15, wherein the first heater is arranged to receive the first fiber layer, and a second heater is arranged to receive the first and second fiber layers after the first compression device compresses the first fiber layer.

17. The machine according to claim 16, wherein the second compression device compresses the first and second fiber layers providing the first fiber layer with a first density that is greater than a second density of the second fiber layer.
